(19) United States
(12) Patent Application Publication
(10) Pub. No.: US 2022/0105740 A1
(43) Pub. Date: Apr. 7, 2022

(54) Multi-Color Retransfer Single Stamping System And Method

(71) Applicant: Illinois Tool Works Inc., Glenview, IL (US)

(72) Inventors: Robert Korson, Traverse City (US); Kenneth Bode, Philadelphia, PA (US); Richard Ellis, Lawford (GB); Daniela Israel, Glenview, IL (US); Michael Colella, Southington, CT (US)

(73) Assignee: Illinois Tool Works Inc., Glenview, IL (US)

(21) Appl. No.: 17/490,189

(22) Filed: Sep. 30, 2021

Related U.S. Application Data
(60) Provisional application No. 63/086,840, filed on Oct. 2, 2020.

(51) Int. Cl. B41K 3/58

(52) U.S. Cl. CPC B41K 3/58

(57) ABSTRACT

A multi-color retransfer single stamping system includes at least one thermal print head configured to print a color from a donor ribbon onto a retransfer film to print indicia on the retransfer film, and thermal stamps configured to apply pressure onto the retransfer film to transfer the indicia from the retransfer film to one or more target objects.

### CROSS-REFERENCE TO RELATED APPLICATIONS

This application claims priority to U.S. Provisional Application No. 63/086,840 (filed 2 Oct. 2020), the entire disclosure of which is incorporated herein by reference.

### BACKGROUND

### Technical Field

The subject matter described herein relates to retransfer printing.

### Discussion of Art

Retransfer printing involves transferring ink from a donor ribbon to a retransfer film, and then applying the retransfer film to an object to transfer the ink to the object (with the film being removed). Retransfer printing has been used to prepare identification (ID) cards. The donor ribbon can have different panels that hold different colored inks or pigments (e.g., yellow, magenta, cyan, and black panels). The inks or pigments diffuse from the ribbon to a coated retransfer film by dye diffusion thermal transfer (D2T2) printing using a thermal printhead. The black panel can be transferred by a mass transfer process. Once the image on the retransfer film is complete, the image is transferred to a card along with a receptor coating on the retransfer film by thermal lamination.

But, retransfer printing may require several back-and-forth movements by the retransfer film to print an image on the film. For example, the retransfer film may be moved in a first direction to print part of the image, then moved in an opposite second direction to print another part of the image (using the same or different inks or pigments in the ribbon), then moved in the first direction again to print another part of the image, and so on. This can introduce difficulties in registering (e.g., aligning) the different parts of the images being printed so that a clear and accurate image is formed. Additionally, some known retransfer printing systems and methods are used to print on rigid, flat objects, such as ID cards. But, these systems and methods are not used to print on a flexible and/or surfaces that are not flat, such as intravenous (IV) bags.

### BRIEF DESCRIPTION

In one embodiment, a multi-color retransfer single stamping system includes at least one thermal print head configured to print a color from a donor ribbon onto a retransfer film to print indicia on the retransfer film, and thermal stamps configured to apply pressure onto the retransfer film to transfer the indicia from the retransfer film to one or more target objects.

In one embodiment, a method includes printing different colors from different donor ribbons onto a retransfer film using thermal print heads to print multi-colored indicia on the retransfer film, and transferring the multi-colored indicia from the retransfer film to one or more target objects using thermal stamps that apply pressure onto the retransfer film.

In one embodiment, a multi-color retransfer single stamping system includes thermal print heads configured to print different colors from different donor ribbons onto a retransfer film to form multi-colored indicia on the retransfer film, and stamps configured to apply one or more of pressure or heat onto the retransfer film to transfer the multi-colored indicia from the retransfer film to one or more target objects.

### BRIEF DESCRIPTION OF THE DRAWINGS

The inventive subject matter may be understood from reading the following description of non-limiting embodiments, with reference to the attached drawings, wherein below:

FIG. 1 illustrates one example of an inline, multi-color, retransfer single stamping system;

FIG. 2 illustrates a printing assembly of an off-line, multi-color, retransfer single stamping system;

FIG. 3 illustrates a transfer assembly of the off-line, multi-color, retransfer single stamping system; and

FIG. 4 illustrates a flowchart of one example of a method for multi-color, retransfer single stamping.

### DETAILED DESCRIPTION

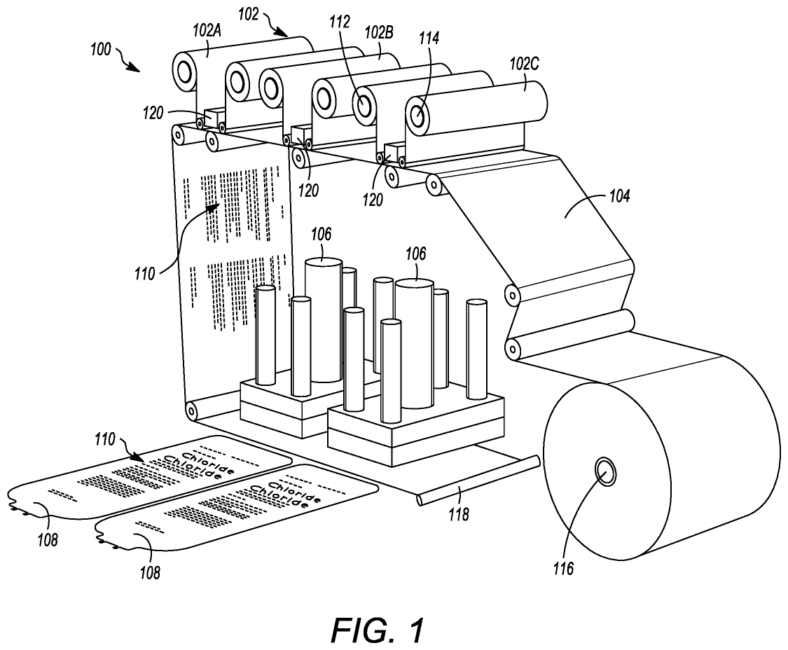

FIG. 1 illustrates one example of an inline, multi-color, retransfer single stamping system 100. The system 100 can be used to transfer several inks or pigments of different colors from two or more donor ribbons 102 (e.g., ribbons 102A-C in FIG. 1) to a retransfer film 104, and then to apply pressure on the retransfer film 104 using thermal stamps 106 (also referred to as heated dies) to transfer the inks or pigments from the donor ribbons 102 from the retransfer film 104 to target objects 108. This can form multi-color images, text, numbers, or the like (e.g., multi-color indicia 110) on the target objects 108. In the illustrated embodiment, the target objects 108 are IV bags with surfaces that receive the inks or pigments and that are not necessarily perfectly flat or planar.

Each of the donor ribbons 102 can be unwound from an unwind reel 112 to a windup reel 114. Alternatively, each of the donor ribbons 102 can be unwound from the reel 114 to the reel 112. Although not shown in FIG. 1, one or more motors or other actuators can rotate the windup reels 114 (or 112) to pull the donor ribbons 102 from the unwind reel 112 to the windup reel 114 (or from the reel 114 to the reel 112). In one embodiment, the donor ribbons 102 may only move in a single direction (e.g., from the unwind reel 112 to the windup reel 114) and not move back-and-forth in opposite directions (at different times) during transfer of inks or pigments from the donor ribbons 102 to the retransfer film 104.

The donor ribbons 102 hold different colored inks or pigments. For example, the donor ribbon 102A may hold a blue ink or pigment in a binder, the donor ribbon 102B may hold a green ink or pigment in a binder, and the donor ribbon 102C may hold a red ink or pigment in a binder. The inks or pigments may be coatings formed from one or more polymeric binders and one or more colored pigments. Alternatively, one or more of the donor ribbons 102 may hold another color of ink or pigment, there may be a greater or fewer number of donor ribbons 102, and/or one or more of the donor ribbons 102 may hold several inks or pigments of different colors (e.g., in different panels or lanes of the donor ribbon(s) 102).

The retransfer film 104 can be unwound from an unwind reel 116 to a windup reel 118. Although not shown in FIG. 1, one or more motors or other actuators can rotate the windup reel 118 to pull the retransfer film 104 from the unwind reel 116 to the windup reel 118. In one embodiment, the retransfer film 104 may only move in a single direction (e.g., from the unwind reel 116 to the windup reel 118) and not move back-and-forth in opposite directions (at different times) during transfer of inks or pigments from the donor ribbons 102 to the retransfer film 104.

Each of the donor ribbons 102 may be associated with a different thermal transfer print head 120 that transfers inks or pigments in the donor ribbons 102 in selected areas to the retransfer film 104 as the retransfer film 104 and the donor ribbons 102 move by the print heads 120. The print heads 120 can be controlled by a control system (e.g., circuitry that includes and/or is connected with one or more processors) to cause the print heads 120 to print variable data and/or invariable data on the retransfer film 104 as the indicia 110. For example, each or at least one of the print heads 120 may print from the associated donor ribbon 102 to print indicia 110 on the retransfer film 104 that is different for each of the objects 108, or that is different for at least two of the objects (e.g., variable data such as serial numbers, dates, data codes, bar codes, etc.). Optionally, each or at least one of the print heads 120 may print from the associated donor ribbon 102 to print indicia 110 on the retransfer film 104 that is the same for each of the objects 108, or that is the same for at least two of the objects (e.g., invariable data such as logos, names, warnings, etc.).

The movement of the retransfer film 104 in only a single direction by the print heads 120 (right to left in FIG. 1) during a single pass of the retransfer film 104 by the print heads 120 to print the indicia 110 on the retransfer film 104 can reduce registration errors in printing multi-color indicia 110 on the retransfer film 104. For example, because the retransfer film 104 need not be moved back and forth while printing from the different print heads 120, there is less chance or likelihood of the different colored indicia 110 printed by each of the print heads 120 being misaligned with each other.

After the multi-color indicia 110 are printed onto the retransfer film 104 by the print heads 120 and the donor ribbons 102, the retransfer film 104 can be moved between the stamps 106 and the target objects 108. The stamps 106 are moved up and down (e.g., by motors or other actuators) to apply pressure onto the side of the retransfer film 104 that is opposite the side of the retransfer film 104 on which the multi-color indicia 110 was printed by the print heads 120. Optionally, the stamps 106 can be heated or include heating elements (e.g., resistive wires). The pressure and/or heat applied by the stamps 106 transfers the inks or pigments on the retransfer film 104 to the target objects 108.

The system 100 is an in-line system due to the system 100 printing the indicia 110 from the donor ribbons 102 to the retransfer film 104 and the system 100 transferring the indicia 110 from the retransfer film 104 to the target objects 108. Alternatively, another multi-color, retransfer single stamping system may be an off-line system, as described below.

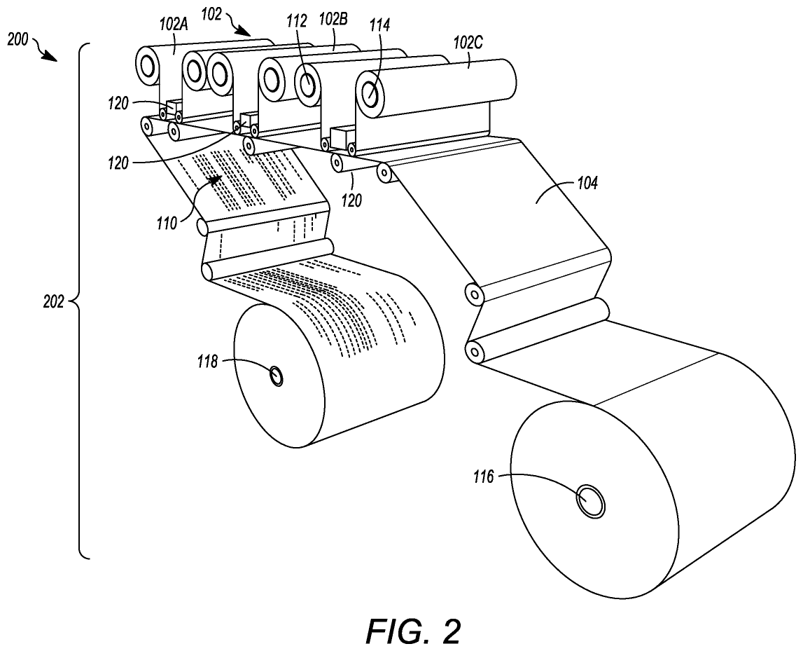

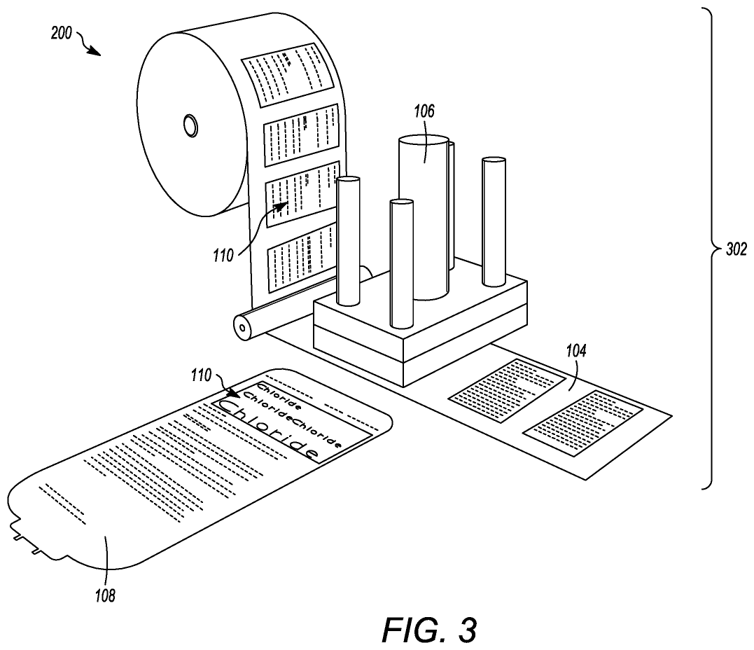

FIGS. 2 and 3 illustrate one example of an off-line, multi-color, retransfer single stamping system 200. FIG. 2 illustrates a printing assembly 202 of the stamping system 200 and FIG. 3 illustrates a transfer assembly 302 of the stamping system 200. The printing assembly 202 can be used to transfer several inks or pigments of different colors from two or more of the donor ribbons 102 to the retransfer film 104. The transfer assembly 302 can apply pressure on the retransfer film 104 using stamps 106 to transfer the inks or pigments from the donor ribbons 102 from the retransfer film 104 to target objects 108. This can form multi-color indicia 110 on the target objects 108, similar to as described above.

One difference between the systems 100, 200 is that the system 200 includes separate assemblies 202, 302 that print and transfer the indicia 110. This can allow for the system 200 to be dispersed between different locations. For example, the printing assembly 202 can be in one location where the retransfer film 104 is printed upon and the transfer assembly 302 can be in another location (e.g., another building, another zip code, etc.) where the retransfer film 104 is used to transfer the indicia 110 onto the target objects 108.

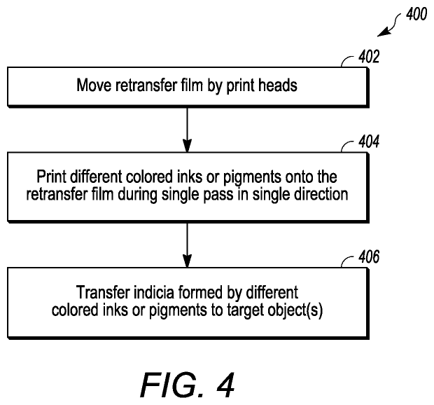

FIG. 4 illustrates a flowchart of one example of a method 400 for multi-color, retransfer single stamping. The method 400 can represent operations performed by one or both of the systems 100, 200 described herein. At 402, a retransfer film is moved by two or more print heads. For example, the retransfer film can be unrolled from an unwind reel and moved above or beneath two or more print heads. At 404, different colored inks or pigments are printed onto the retransfer film by the print heads to form indicia on the retransfer film. For example, each print head may transfer a different colored ink or pigment onto the same or different locations on the retransfer film. The printing of the inks or pigments onto the retransfer film can occur while the retransfer film moves in a single direction beneath or above the print heads during a single pass of the retransfer film by the print heads. At 406, the indicia on the retransfer film is transferred from the film to one or more target objects. The indicia can be transferred by applying heat and/or pressure onto the retransfer film by stamps. As described above, the printing of indicia onto the retransfer film and the transfer of the indicia from the film to the target objects can occur in-line with the same assembly or system, or may occur off-line with assemblies located in different locations.

In one embodiment, a multi-color retransfer single stamping system includes at least one thermal print head configured to print a color from a donor ribbon onto a retransfer film to print indicia on the retransfer film, and thermal stamps configured to apply pressure onto the retransfer film to transfer the indicia from the retransfer film to one or more target objects.

The thermal print head may print the indicia from the donor ribbon onto the retransfer film during a single pass of the retransfer film by the thermal print head. The thermal print head may print variable data in the indicia from the donor ribbon onto the retransfer film. The thermal stamps may transfer the variable data in the multi-colored indicia from the retransfer film onto the one or more target objects.

The thermal print head may print the variable data and invariable data in the multi-colored indicia onto the retransfer film in locations such that both the variable data and the invariable data are transferred from the retransfer film onto the same target object of the one or more target objects by at least one of the thermal stamps. The thermal print head may print the multi-colored indicia from the donor ribbon onto the retransfer film while the retransfer film moves by the thermal print heads in only a single direction.

The thermal stamps may transfer the multi-colored indicia from the retransfer ribbon onto intravenous (IV) bags as the one or more target objects. The stamping system may be an inline stamping system or an off-line stamping system.

In one embodiment, a method includes printing different colors from different donor ribbons onto a retransfer film using thermal print heads to print multi-colored indicia on the retransfer film, and transferring the multi-colored indicia from the retransfer film to one or more target objects using thermal stamps that apply pressure onto the retransfer film.

The multi-colored indicia may be printed from the different donor ribbons onto the retransfer film during a single pass of the retransfer film by the thermal print heads. The different colors may be printed to form (e.g., print) variable data in the multi-colored indicia from the different donor ribbons onto the retransfer film. The variable data in the multi-colored indicia may be transferred from the retransfer film onto the one or more target objects. The variable data and invariable data may be printed in the multi-colored indicia onto the retransfer film in locations such that both the variable data and the invariable data are transferred from the retransfer film onto the same target object of the one or more target objects by at least one of the thermal stamps.

The multi-colored indicia may be printed from the different donor ribbons onto the retransfer film while the retransfer film moves by the thermal print heads in only a single direction. The multi-colored indicia may be transferred from the retransfer ribbon onto IV bags as the one or more target objects.

Printing the multi-colored indicia and transferring the multi-colored indicia may occur at the same location using an inline stamping system or may occur at different locations using an off-line stamping system.

In one embodiment, a multi-color retransfer single stamping system includes thermal print heads configured to print different colors from different donor ribbons onto a retransfer film to form multi-colored indicia on the retransfer film, and stamps configured to apply one or more of pressure or heat onto the retransfer film to transfer the multi-colored indicia from the retransfer film to one or more target objects.

The thermal print heads may print the multi-colored indicia from the different donor ribbons onto the retransfer film during a single pass of the retransfer film by the thermal print heads.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A multi-color retransfer single stamping system comprising:
at least one thermal print head configured to print indicia from a donor ribbon onto a retransfer film to print indicia on the retransfer film; and
thermal stamps configured to apply pressure onto the retransfer film to transfer the indicia from the retransfer film to one or more target objects.

2. The stamping system of claim 1, wherein the thermal print head is configured to print the indicia from the donor ribbon onto the retransfer film during a single pass of the retransfer film by the thermal print head.

3. The stamping system of claim 1, wherein the thermal print head is configured to print variable data in the indicia from the donor ribbon onto the retransfer film.

4. The stamping system of claim 3, wherein the thermal stamps are configured to transfer the variable data in the multi-colored indicia from the retransfer film onto the one or more target objects.

5. The stamping system of claim 3, wherein the thermal print head is configured to print the variable data and invariable data in the multi-colored indicia onto the retransfer film in locations such that both the variable data and the invariable data are transferred from the retransfer film onto the same target object of the one or more target objects by at least one of the thermal stamps.

6. The stamping system of claim 1, wherein the thermal print head is configured to print the indicia from the donor ribbon onto the retransfer film while the retransfer film moves by the thermal print heads in only a single direction.

7. The stamping system of claim 1, wherein the thermal stamps are configured to transfer the multi-colored indicia from the retransfer film onto intravenous (IV) bags as the one or more target objects.

8. The stamping system of claim 1, wherein the stamping system is an inline stamping system.

9. The stamping system of claim 1, wherein the stamping system is an off-line stamping system.

10. A method comprising:
printing different colors from different donor ribbons onto a retransfer film using thermal print heads to print multi-colored indicia on the retransfer film; and
transferring the multi-colored indicia from the retransfer film to one or more target objects using thermal stamps that apply pressure onto the retransfer film.

11. The method of claim 10, wherein the multi-colored indicia are printed from the different donor ribbons onto the retransfer film during a single pass of the retransfer film by the thermal print heads.

12. The method of claim 10, wherein the different colors are printed to print variable data in the multi-colored indicia from the different donor ribbons onto the retransfer film.

13. The method of claim 12, wherein the variable data in the multi-colored indicia is transferred from the retransfer film onto the one or more target objects.

14. The method of claim 12, wherein the variable data and invariable data are printed in the multi-colored indicia onto the retransfer film in locations such that both the variable data and the invariable data are transferred from the retransfer film onto the same target object of the one or more target objects by at least one of the thermal stamps.

15. The method of claim 10, wherein the multi-colored indicia are printed from the different donor ribbons onto the retransfer film while the retransfer film moves by the thermal print heads in only a single direction.

16. The method of claim 10, wherein the multi-colored indicia are transferred from the retransfer ribbon onto intravenous (IV) bags as the one or more target objects.

17. The method of claim 10, wherein printing the multi-colored indicia and transferring the multi-colored indicia occur at the same location using an inline stamping system.

18. The method of claim 10, wherein printing the multi-colored indicia and transferring the multi-colored indicia occur at different locations using an off-line stamping system.

19. A multi-color retransfer single stamping system comprising:
thermal print heads configured to print different colors from different donor ribbons onto a retransfer film to form multi-colored indicia on the retransfer film; and
stamps configured to apply one or more of pressure or heat onto the retransfer film to transfer the multi-colored indicia from the retransfer film to one or more target objects.

20. The stamping system of claim 19, wherein the thermal print heads are configured to print the multi-colored indicia from the different donor ribbons onto the retransfer film during a single pass of the retransfer film by the thermal print heads.
